(19) United States
(12) Patent Application Publication
(10) Pub. No.: US 2022/0234511 A1
(43) Pub. Date: Jul. 28, 2022

(54) VEHICLE REAR ROOF CARRIER DEVICE

(71) Applicant: Soon Jung KO, Daejeon (KR)

(72) Inventor: Soon Jung KO, Daejeon (KR)

(21) Appl. No.: 17/607,610

(22) PCT Filed: May 20, 2019
(86) PCT No.: PCT/KR2019/005990

§ 371 Date: Oct. 29, 2021

(51) Int. Cl. B60R 9/045; B60R 9/055; B60R 9/058; B60R 9/06

(52) U.S. Cl. CPC B60R 9/045; B60R 9/06; B60R 9/058; B60R 9/055

(57) ABSTRACT

The present invention relates to a carrier device installed on a vehicle roof and, more specifically, to a vehicle rear roof carrier device comprising: roof supports fixed to both sides of a vehicle roof in the lengthwise direction; hollow roof fixing rails connected and fixed to side portions of the roof supports, respectively; operation rails disposed on the roof fixing rails and connected to a trunk; a transfer cart which slides along the roof fixing rails; and a carrier box which can be attached or detached to the transfer cart and stores an object therein, wherein the operation rails are connected to the rear portion of the trunk and the transfer cart is transferred and lowered along the roof fixing rails and the operation rails to allow an object to be stored in the carrier box, so that an item can be conveniently loaded or unloaded in the carrier box provided on the vehicle roof through the rear side of a vehicle.

### TECHNICAL FIELD

The present invention relates to a carrier device installed on the roof of a vehicle and, more specifically, to a vehicle rear roof carrier device including roof supports fixed on two opposite sides of the roof of a vehicle in the length direction thereof, hollow roof fixing rails individually connected and fixed to the side surfaces of the roof supports, moving rails provided to the roof fixing rails and connected and installed up to the trunk, a moving cart slid along the roof fixing rails, and a carrier box detachable from the moving cart and receiving and storing articles, in which the moving rails are connected and installed up to a rear portion of the trunk, and the moving cart is moved down along the moving rails to load the carrier box with an article, so that it is possible to conveniently move down or up the carrier box to/from the roof of the vehicle to load or unload an article.

### BACKGROUND ART

In general, a roof carrier device is installed on the roof of a vehicle to load and carry articles or things.

The conventional roof carrier for a vehicle has roof carrier bars installed on two opposite sides on the roof of the vehicle and an article storage box installed on a roof carrier support connecting the roof carrier bars.

The conventional roof carrier box is one installed to load luggage or skis on the roof of a vehicle. The roof carrier box is installed on multiple support rods crossing two roof racks installed in the length direction of the vehicle on the roof of the vehicle.

Such vehicle roof carrier and box are cargo loading means installed on the roof panel of a vehicle to load bulky and relatively light loads, such as skis, bicycles, leisure boxes, and other items and provide convenience for various uses, e.g., leisure and travel, and are equipped primarily in recreational vehicles.

However, the conventional roof carrier for automobiles requires a lot of force to load and unload cargo on/from the roof carrier support installed between the roof carrier bars because the roof carrier bars (racks) are fixed to the roof panel. Further, loading and unloading cargo on/from a roof carrier (or box) installed on a high vehicle, e.g., a van, requires use of a ladder which is very cumbersome.

Conventional vans, RVs, or SUVs have an auxiliary carrier on the rear in addition to the roof carrier (or carrier box) to carry more items.

According to the conventional art, the carrier box installed on the roof carrier (rails) on the roof of a vehicle are slid down along the rear auxiliary carrier (rails) to load or unload an article at the rear of the vehicle. However, the roof carrier is spaced apart from the auxiliary carrier by a certain distance (separated section). Thus, in the separated section, the carrier box may not seamlessly be slid down or may even escape off the separated section.

### PRIOR TECHNICAL DOCUMENTS

### Patent Documents

(Patent Document 1) KR 10-1709147 registered on Feb. 16, 2017.
(Patent Document 2) KR 20-1998-0039092 published on Sep. 15, 1998.
(Patent Document 3) KR 20-1999-0024979 published on Jul. 5, 1999.

### DETAILED DESCRIPTION OF THE INVENTION

### Technical Problems

The present invention has been conceived to address the foregoing issues and aims to provide a vehicle rear roof carrier device including roof supports fixed on two opposite sides of the roof of a vehicle, roof fixing rails, moving rails slid along the insides of the roof fixing rails to extend or contract, a moving cart slid along the roof fixing rails, and a carrier box detachable from the moving cart and receiving and storing articles, in which the moving rails are extended and supported on the rear side of the trunk, and the moving cart is moved down to the ground along the roof fixing rails and the moving rails to load the carrier box with an article, so that it is possible to conveniently load and unload an article as the carrier box is moved from the roof of the vehicle to the rear of the vehicle.

Another object of the present invention is to conveniently move down the moving cart to the ground. To that end, the moving rails extendably or contractably drawn in or out the insides of the roof fixing rails provided on the roof of the vehicle include flexible bending sections in the middle portions thereof, and the user may extend the moving rails from the roof fixing rails and easily bend and support the moving rails to the outer surface of the trunk of the vehicle by applying force.

Another operation of the present invention is to increase the efficiency of cargo loading or unloading through a carrier box by allowing the carrier box to quickly be attached or detached to/from the moving cart.

### Means to Address the Problems

To achieve the foregoing objectives, the present invention comprises a pair of roof supports 110 installed on two opposite sides in a length direction of a vehicle roof on an upper surface of the vehicle roof, hollow roof fixing rails 120 connected and fixed to the roof supports 110, moving rails 130 installed on the roof fixing rails 120 and extending up to a rear surface of a vehicle trunk, a moving cart 140 installed on the roof fixing rails 120 and slid along outer surfaces of the roof fixing rails 120 and outer surfaces of the moving rails 130, and a carrier box 150 installed on an upper surface of the moving cart 140 to receive and store an article.

Further, according to the present invention, the moving rails 130 are drawn out from insides of the roof fixing rails 120 and ends of the moving rails 130 are supported on the rear surface of the vehicle trunk.

Further, according to the present invention, the moving rails 130 are installed in pair on two opposite sides on the vehicle roof to face each other. A connection bracket 131 is provided at respective ends of the moving rails 130 to connect the moving rails 130. An operating handle 132 is installed on the connection bracket 131 to draw the moving rails 130 in or out of the roof fixing rails 120.

Further, according to the present invention, bending parts 133 are provided in middle portions of the moving rails 130, each bending part 133 formed of a flexible connecting rod 133a over which a plurality of rigid rings 133b spaced apart from each other are fitted.

Further, according to the present invention, the moving cart 140 includes a plate-shaped body plate 141 on which the carrier box 150 is mounted, roller units 142 having first sides fixed and installed on a lower surface of the body plate 141 and second sides mounted and rollable on the roof fixing rails 120 and provided with rotation rollers 142R, and a locking bracket 143 provided on a rear lower surface of the body plate 141 and where the operating handle 132 is locked or unlocked to/from the moving rails 130 while being supported.

Further, according to the present invention, a cylinder device 160 including front cylinders 161 and rear cylinders 162 extendable or contractable forward or rearward is installed on the lower surface of the moving cart 140. First ends of the front cylinders 161 are connected to a lower front side of the body plate 141, and second ends of the front cylinders 161 are connected to rear roller units 142b of the roller units 142, and first ends of the rear cylinders 162 are connected to a lower rear side of the body plate 141, and second ends of the rear cylinders 162 are connected to front roller units 142a of the roller units 142, so that the moving cart 140 ascends or descends as the front cylinders 161 and the rear cylinders 162 extend or contract.

Further, according to the present invention, the operating handle 132 includes a body part 132a provided in the middle portion of the connection bracket 131 and having a recess portion 132ab at an upper end thereof, which is supported to the locking bracket 143 provided on the lower surface of the moving cart 140, a handle part 132b provided at a lower end of the body part 132a, an operation part 132c provided in the handle part 132b, and a locking structure 132d provided on a side of an upper portion of the body part 132a and pivoted by the operation part 132c to be locked or unlocked to/from the locking bracket 143.

Further, according to the present invention, the moving rails 130 are connected from the roof fixing rails 120 to the vehicle trunk. Second bending parts 230 are provided in connection portions between the roof fixing rails 120 and the moving rails 130 and are bent outward of the vehicle trunk.

Further, according to the present invention, the second bending parts 230 are bendable in a form of a chain with a plurality of joint structures 231 connected consecutively. Each of the plurality of joint structures 231 includes an upper plate 231a forming an upper surface thereof and a pair of side plates 231b formed downward from two opposite surfaces of the upper plate 231a.

Further, according to the present invention, a first side portion of each of the side plates 131b includes a rounded protruding portion 231c having a first pivot pin hole h1 through which a pivot pin 231p is inserted, and a second side portion thereof includes a recess portion 231d having a second pivot pin hole h2 through which a pivot pin 231p is inserted. A rounded protruding portion 231c is rotatably fitted into the recess portion 231d.

Further, according to the present invention, an upper jaw 231e formed by a front end of the upper plate 231a is provided on an upper surface of the rounded protruding portion 231c, and a lower jaw 231f is provided on a lower surface of the rounded protruding portion 231c. An upper distance L1 from a rear surface of the upper plate 231a to the upper jaw 231e is larger than a lower distance L2 from a rear lower end of the side plate 231b to the lower jaw 231f.

Further, according to the present invention, a fixing pin 133c penetrating the connecting rod 133a is fixed to each of the rings 133b.

Further, according to the present invention, an interval between lower sides of the rings 133b is equal to or larger than an interval between upper sides of the rings 133b.

Further, according to the present invention, upper rails 144 are provided in the length direction on an upper surface of the moving cart 140, and lower rails 151 are provided on a lower surface of the carrier box 150 to slide along the upper rails 144. The carrier box 150 is slid down along the upper rails 144 and is then detached from the moving cart 140.

Further, according to the present invention, upper rails 144 are provided in the length direction on an upper surface of the moving cart 140, and lower rails 151 are provided on a lower surface of the carrier box 150 to be coupled with the upper rails 144. The upper rails 144 have pivotable links. The carrier box 150 is moved down by rotation of the links and is then detached from the moving cart 140.

### Effects of the Invention

According to the present invention, in the vehicle rear roof carrier device, the moving rails inserted to the roof rails provided on two opposite sides of the roof of a vehicle are extended to be supported on the rear of the trunk. The moving cart is moved down to the ground along the roof fixing rails and the moving rails so as to load the carrier box with a cargo. As the carrier box is moved from the roof of the vehicle to the rear of the vehicle, it is possible to conveniently load or unload a cargo.

Further, according to the present invention, the moving rails extendably or contractably drawn in or out the insides of the roof fixing rails provided on the roof of the vehicle include flexible bending sections in the middle portions thereof, and the user may extend the moving rails from the roof fixing rails and easily bend and support the moving rails to the outer surface of the trunk of the vehicle by applying force. Thus, it is possible to quickly move down the moving cart to the ground and provide work convenience.

Further, according to the present invention, it is possible to increase the efficiency of cargo loading or unloading through a carrier box by allowing the carrier box to quickly be attached or detached to/from the moving cart.

### BRIEF DESCRIPTION OF THE DRAWINGS

FIG. 1 is a perspective view schematically illustrating a vehicle rear roof carrier device mounted on the roof of a vehicle according to the present invention;

FIG. 2 is a cross-sectional view schematically illustrating a vehicle rear roof carrier device mounted on the roof of a vehicle according to the present invention;

FIG. 3 is an exploded perspective view illustrating a vehicle rear roof carrier device according to the present invention;

FIG. 4 is a view illustrating a state in which operation rails of a vehicle rear roof carrier device are stretched along fixing rails and are bent to a trunk according to the present invention;

FIG. 5 illustrates a major parts and operation state of a cart of a vehicle rear roof carrier device according to the present invention;

FIG. 6 illustrates a state in which a cart of a vehicle rear roof carrier device is expanded to the rear of the trunk and the ground along roof fixing rails and operation rails according to the present invention;

FIG. 7 illustrates a state in which a cart of a vehicle rear roof carrier device is expanded at the rear of the trunk and a carrier box is then lowered to a lower surface through a link according to the present invention; and

FIG. 8 schematically illustrates operation rails of a vehicle rear roof carrier device according to another embodiment of the present invention.

### BEST MODE TO PRACTICE THE INVENTION

Hereinafter, preferred embodiments of the present invention are described with reference to the accompanying drawings to be easily practiced by one of ordinary skill in the art.

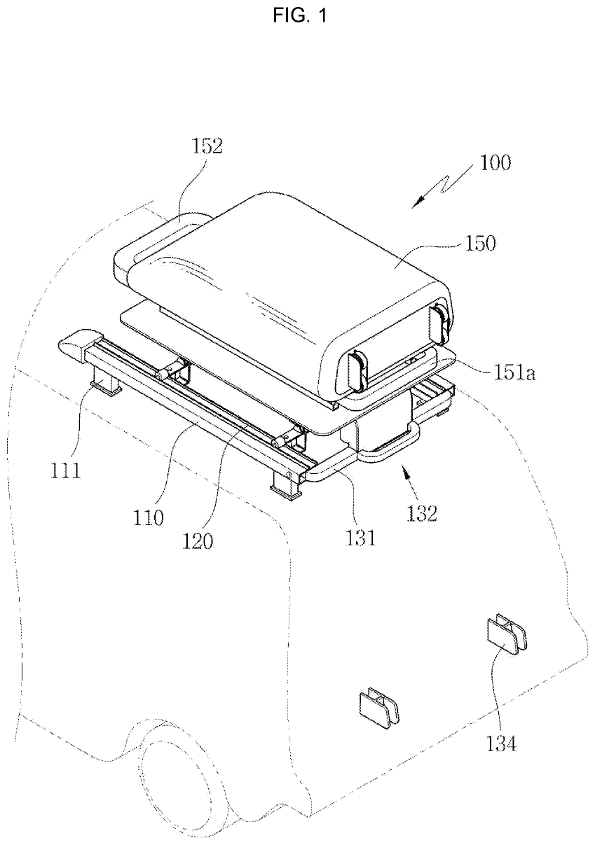

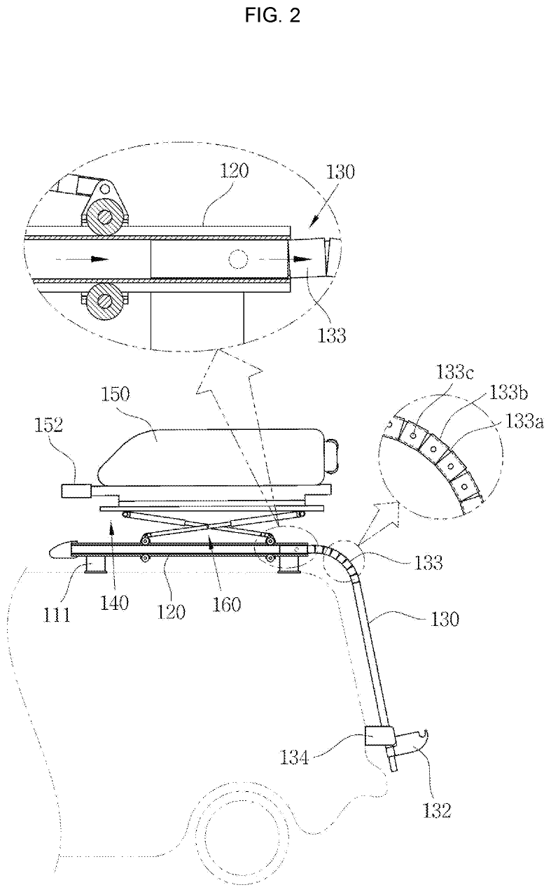

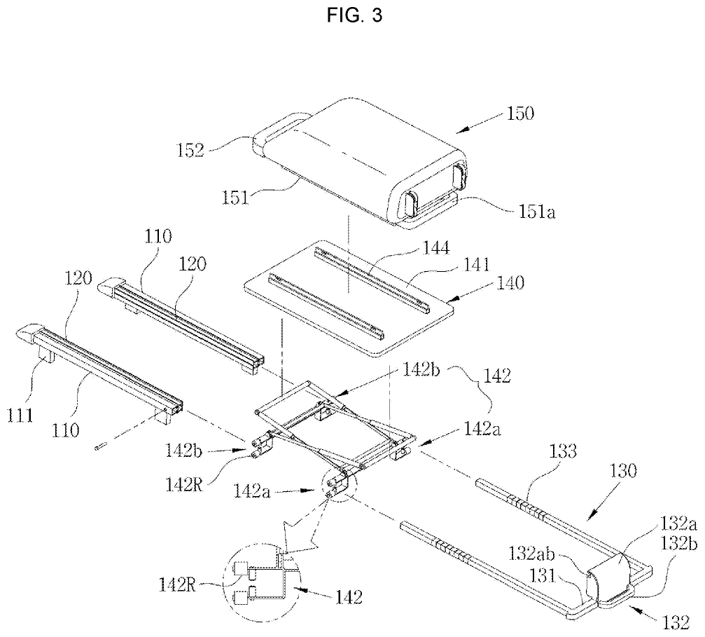

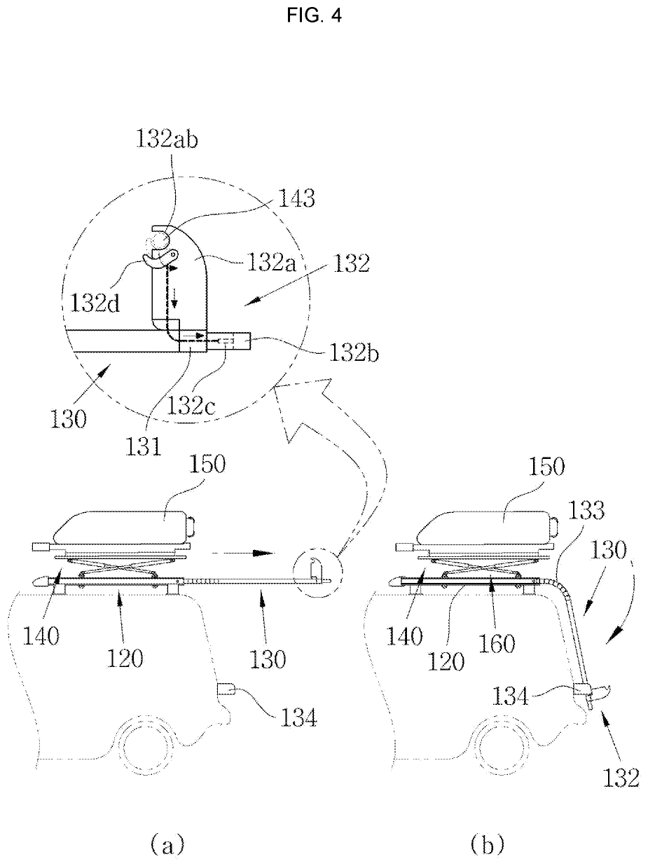

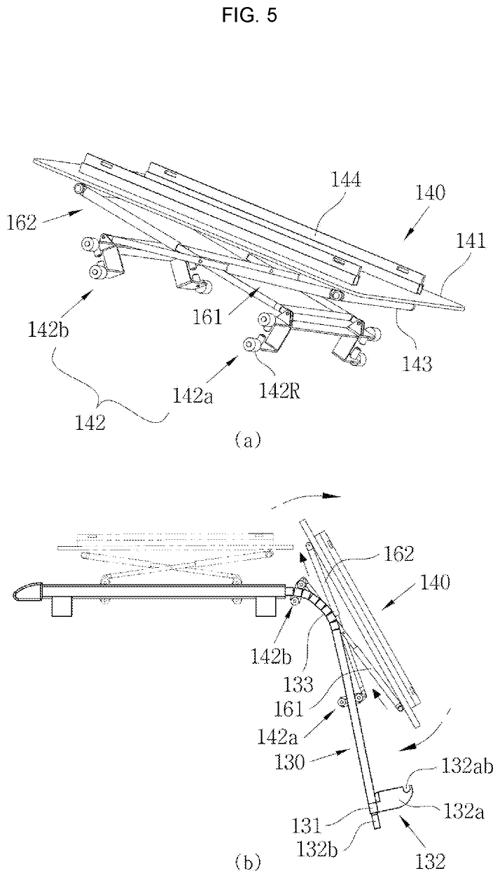

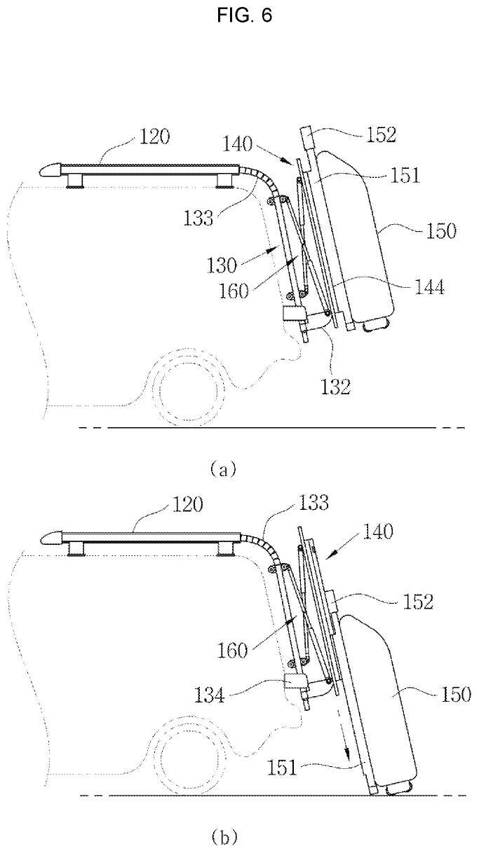

Referring to FIGS. 1 to 8, according to the present invention, a vehicle rear roof carrier device 100 includes

a pair of roof supports 110 installed on two opposite sides in a length direction of a vehicle roof R on the vehicle roof (also referred to as a ‘roof’ or ‘roof panel’),

hollow roof fixing rails 120 connected and fixed to the roof supports 110,

moving rails 130 installed to be drawn in or out of the roof fixing rails 120,

a moving cart 140 installed on the roof fixing rails 120 and slid along outer surfaces of the roof fixing rails 120 from the vehicle roof panel to a rear surface of a trunk at the rear of the vehicle, and

a carrier box 150 installed on the moving cart 140 to receive and store things or articles.

A typical vehicle roof carrier and box is cargo loading means installed on the roof of a vehicle (including a general passenger car, a SUV, or an RV) to load bulky and relatively light loads, such as skis, bicycles, leisure boxes, and other items and provide convenience for various uses, e.g., leisure and travel, and are equipped primarily in recreational vehicles.

According to the present invention configured as above, the moving rails 130 are drawn out (extracted) from the roof fixing rails 120 installed on the roof panel of the vehicle and are slid down the rear of the vehicle. Then, the moving cart 140 is moved along the moving rails 130 from the roof fixing rails 120. Then, the articles received in the carrier box 150 on the moving cart 140 are unloaded. Or, after loaded with articles, the carrier box 150 is slid up and fixed to the roof supports 110 and thus effectively carries articles or things which cannot be loaded inside the vehicle.

In this case, if the weight of the carrier box 150 is light, the moving rails 130 may be drawn out and transported together with the moving cart 140. The carrier box 150 and the moving cart 140 may be coupled or decoupled depending on whether they are locked together.

Bases 111 may be installed on the vehicle roof panel to fix the roof supports 110, with the roof supports 110 spaced apart from the upper surface of the roof by a predetermined height. Alternatively, without the bases 111, the roof supports 110 may be tightly installed on the roof panel.

The roof supports 110 are fixed and installed on the vehicle roof panel on two opposite sides in parallel in the length direction of the vehicle roof panel.

The roof fixing rails 120 are fixed to the respective sides surfaces of the roof supports 110 and each of the roof fixing rails 120 is formed in a hollow rectangular bar shape. Alternatively, the roof fixing rails 120 may be installed on the respective upper surfaces of the roof supports 110.

The moving rails 130 are installed to be slidably drawn in or out of the insides of the roof fixing rails 120.

The moving rails 130 may be extended from the roof fixing rails 120 up to the rear of the trunk. If the moving rails 130 are one-stage moving rails 130, the roof fixing rails 120 need to be sufficiently long to allow the moving rails 130 to extend up to the rear of the trunk. As necessary, the moving rails 130 may be formed in a multi-stage structure to be stretchable and contractable.

The moving rails 130 are installed on two opposite sides on the vehicle roof to face each other. A connection bracket 131 is provided at the respective first ends of the moving rails 130 to connect the moving rails 130. An operating handle 132 is installed on the connection bracket 131 to draw the moving rails 130 in or out of the roof fixing rails 120.

Thus, the moving rails 130 may be drawn in or out of the roof fixing rails 120 by pushing in or pulling out the operating handle 132.

Further, bending parts 133 which are bendable are formed in the respective middle portions of the moving rails 130. Each bending part 133 includes a connecting rod 133a formed of a flexible material and fitting media 133b fitted over the connecting rod 133a and spaced apart from each other.

In other words, the bending part 133 includes the connecting rod 133a formed of a flexible material that is bent when pressurized, and a plurality of rigid rings 133b spaced apart from each other are fitted over the connecting rod 133a. The rings may be formed in a circular or rectangular shape. When the bending part 133 is pressurized and bent, the respective lower ends of the rings come in contact with each other, thus preventing further bending, while the opposite ends (outer sides) thereof are further spaced apart from each other than when the bending part 133 is not bent. A fixing pin 133c may be installed in the center of each ring 133b to pass through the connecting rod 133a to prevent the ring from moving from the connecting rod 133a. Such fixing pins 133c support each other without moving from the connecting rod although the bending part 133 is warped so that the lower ends of the rings are pushed to come in contact with each other. These multiple rings may be regarded as forming multiple joints. Although the bending part 133 is bent, the moving cart 140 may be moved without sagging through the rigid joints. The bending part 133 may be changed into various shapes. For example, as shown in FIG. 9, the bending part 133 may be bent as rotation rings are continuously connected.

Meanwhile, as shown in FIG. 9, the bending part 133 is applicable even when installed on the rear of the vehicle, rather than expanding. In this case, if the trunk of the vehicle is opened, the bending part 133 is warped upward as shown in (b) of FIG. 9. At this time, the lower surfaces of the rings 133b come in contact with each other while pushing each other, bending the connecting rod 133a. The upper and lower ends of the rings 133b may have the same interval and, when the trunk is open, the interval between the lower ends may be longer than the interval between the upper ends.

In the moving rails 130 configured as described above, if the operating handle 132 is pulled out, the moving rails 130 are drawn out (stretched) from the roof fixing rails 120 and, in this state, if the operating handle 132 is bent downwards, the bending part 133 is bent and the moving rails 130 are supported on the trunk of the housing.

Here, a rear supporting bracket 134 may be further installed on the trunk of the vehicle so that the ends of the moving rails 130 may be stably supported on the trunk.

Meanwhile, the moving cart 140 includes a plate-shaped body plate 141 on which the carrier box 150 is mounted, U-shaped roller units 142 having first sides fixed and installed on the lower surface of the body plate 141 and second sides mounted and rollable on the roof fixing rails 120 and provided with upper, lower, and side rotation rollers 142R, and a locking bracket 143 provided on a rear lower side of the body plate 141 and where the operating handle 132 is locked or unlocked while being supported.

The body plate 141 has a flat plate shape, and the carrier box 150 is mounted and stably supported on the upper surface of the body plate 141.

Further, the roller units 142 include a pair of front roller units 142a on the front lower surface of the body plate 141 and a pair of rear roller units 142b on the rear lower surface of the body plate 141. The roller units 142 are stuck to the roof fixing rails 120 and the moving rails 130 and are thus prevented from escaping off even when the moving cart 140 is on the move.

In the so-configured moving cart 140, the rotation rollers of the roller units 142 provided under the body plate 141 may roll and move forward or backward on the roof fixing rails 120.

Further, when the moving rails 130 are extended from the roof fixing rails 120 and bent up to the lower end of the vehicle trunk and supported, the moving cart 140 is moved through the roof fixing rails 120 up to the ends of the moving rails 130.

In this case, as the operating handle 132 is seated and locked to the locking bracket 143 provided under the body plate 141, the moving cart 140 is fixed and supported.

Further, a cylinder device 160 that extends and contracts forward or backward so as to stably slide along the bending part 133 is installed on the lower surface of the moving cart 140.

The cylinder device 160 includes a pair of front cylinders 161 and a pair of rear cylinders 162. The respective first ends of the front cylinders 161 are pivotally connected to a front lower portion of the body plate 141, and the respective second ends of the front cylinders 161 are pivotally connected to the rear roller units 142b so as to be extended or contracted. The respective first ends of the rear cylinders 162 are pivotally connected to a rear lower portion of the body plate 141, and the respective second ends of the rear cylinders 162 are pivotally connected to the front roller units 142a so as to be extended or contracted.

Therefore, when the moving cart 140 slides through the bending part 133 section, the front cylinders 161 and the rear cylinders 162 are extended from each other so that the moving cart 140 may be further away from the moving rails 130 and be stably bent and slid.

In other words, the moving rails 130 are extended through the bending parts 133 and are then bent to the rear of the vehicle trunk and supported. In the state, the moving cart 140 is slid forward on the roof fixing rails 120 and, while sliding along the moving rails 130, the moving cart 140 may be abruptly turned down along the sharply curved bending part 133 section. At this time, the front cylinders 161 are contracted while the rear cylinders 162 are extended, so that the moving cart 140 may stably slide downward. Conversely, when the moving cart 140 slides up along the moving rails 130, the moving cart 140 is abruptly turned along the sharply curved bending part 133 section. At this time, the front cylinders 161 are extended while the rear cylinders 162 are contracted, so that the moving cart 140 may stably slide up onto the roof fixing rails 120.

Meanwhile, the operating handle 132 includes a body part 132a provided in the middle portion of the connection bracket 131 and having a recess portion 132ab at an upper end thereof, which is supported to the locking bracket 143 provided on the lower surface of the moving cart 140, a handle part 132b provided at a lower end of the body part 132a, an operation part 132c provided in the handle part 132b, and a locking structure 132d provided on a side of an upper portion of the body part 132a and pivoted by the operation part 132c to be locked or unlocked to/from the locking bracket 143. The locking bracket 143 fastens or separates the moving cart 140 and the moving rails 130 to allow the moving rails 130 alone to be drawn out or allow the moving rails 130 to be drawn out in a coupled state of the moving rails 130 and the moving cart 140.

In the configuration in which the locking structure 132d is rotated by the operation part 132c to be locked to or unlocked from the locking bracket 143, a connection line, e.g., a cable, together with a tensioning means (not shown), is installed in the body part 132a so that if the operation part 132c is pressed, the locking structure 132d is rotated to be unlocked from the locking bracket 143. This configuration may be easily implemented by one of ordinary skill in the art from known art, and thus, no detailed description thereof is given. Meanwhile, no description is present of a separate locking unit for locking or unlocking to draw out the moving rails 130 from the roof fixing rails 120.

Further, upper rails 144 are provided on two opposite sides along the length direction thereof on the moving cart 140 to attach or detach the carrier box 150. Lower rails 151 are provided on two opposite sides along the length d reception thereof on the lower surface of the carrier box 150 to be inserted to the upper rails 144 to slide up or down therealong.

If the upper rails 144 and the lower rails 151 are coupled, the carrier box 150 may be rendered to slidably move up or down on the upper surface of the moving cart 140.

Further, a damper (not shown) and a handle 151a may further be installed on the lower ends of the lower rails 151 and the upper rails 144 to prevent the carrier box 150 from abruptly descending. If the handle 151a is pulled out, the upper rails 144 and the lower rails 151 are fastened so that the moving cart 140 and the carrier box 150 are moved together.

Further, a carrier handle 152 is provided on an upper surface of the carrier box 150, and a detaching lever 153 for detaching the carrier box 150 is provided on the carrier handle 152.

The configuration in which the carrier box 150 is detachable from the moving cart 140 by the detaching lever 153 may be easily implemented by one of ordinary skill in the art from known art, and no detailed description thereof is thus given.

According to the present invention configured as above, after the moving cart 140 is slid to the ends of the moving rails 130, with the carrier box 150 fixed to the moving cart 140, if the carrier box 150 is unlocked, the lower rails 151 descend along the upper rails 144 so that the carrier box 150 is landed on the ground. In this case, the carrier box 150 is safely landed on the ground by the damper provided on the lower ends of the lower rails 151 and the upper rails 144. In this state, the detaching lever 153 is pressed, detaching the carrier box 150. Then, a cargo is received in the carrier box 150.

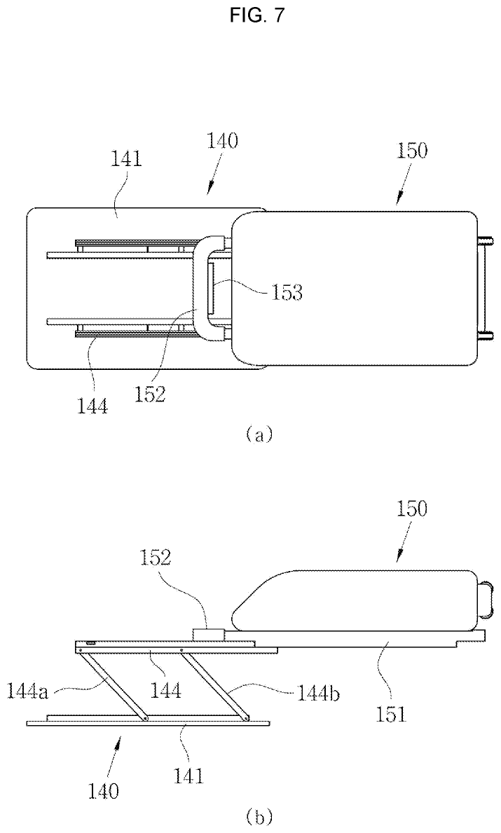

The carrier box 150 of the present invention may be configured as another embodiment as shown in FIG. 7.

In other words, the upper rails 144 installed on the upper surface of the moving cart 140 are configured to be pivoted by upper links 144a and lower links 144b pivotally installed on the upper surface of the moving cart 140.

According to the present invention configured as such, after the moving cart 140 is slid up to the ends of the moving rails 130, with the carrier box 150 fixed to the moving cart 140, locking (the locking configuration is implemented by known art) of the upper links 144a and the lower links 144b are unlocked and then rotated. Subsequently, the lower rails 151 are slid down along the upper rails 144, so that the carrier box 150 is landed on the ground. In this state, the detaching lever 153 is pressed, detaching the carrier box 150. Then, a cargo is received in the carrier box 150.

According to the present invention configured as above, after the moving rails 130 are moved down to the rear of the trunk of the vehicle, the moving cart 140 and the carrier box 150 may be moved, or the moving rails 130 may be slid while the moving cart 140 and the carrier box 150 are moved.

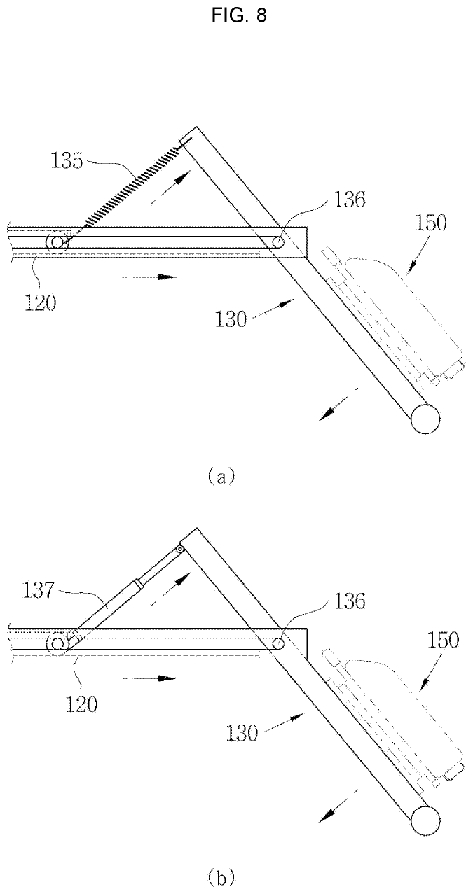

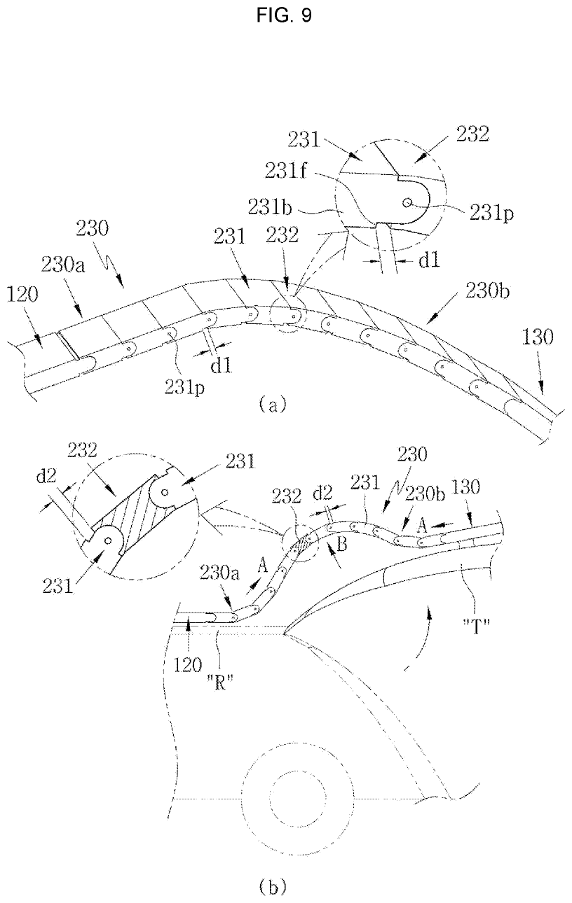

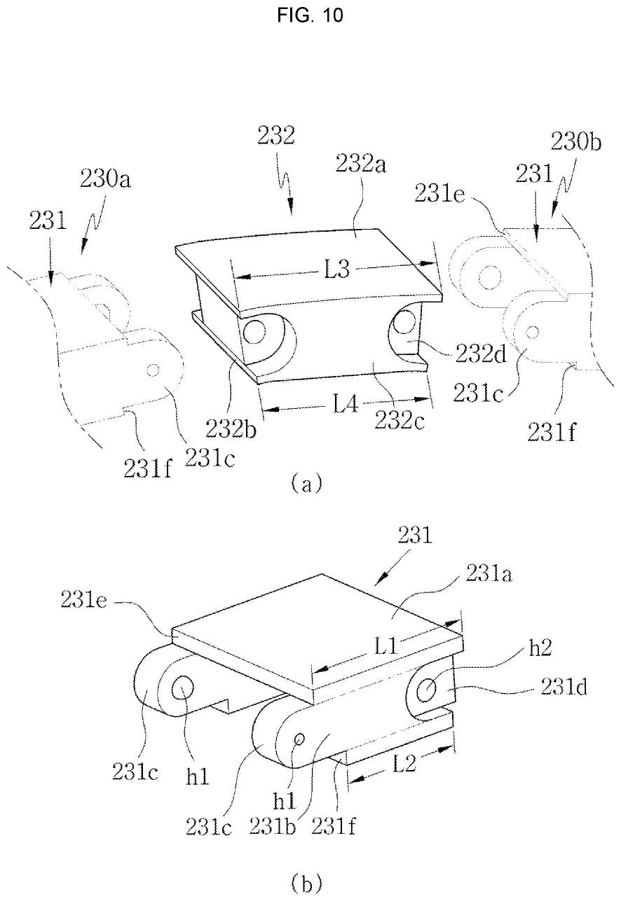

Further, according to the present invention, as shown in FIG. 8, the moving rails 130 may be formed in various configurations. In other words, as shown in (a) of FIG. 8, the moving rails 130 may be inserted in the roof fixing rails 120 to be able to be drawn in or out, and elastic springs 135 may be elastically connected to internal ends thereof. By such configuration, if the moving rails 130 are extended, the elastic springs 135 are slid and, when reaching the stoppers, are extended upwards. At this time, the moving rails 130 are pivoted by the pivot pins 136 provided at the ends of the roof fixing rails 120 so that the ends of the moving rails 130 are positioned to the rear of the trunk. Then, the carrier box 150 is moved to the ground to load or unload the cargo. As shown in (b) of FIG. 8, extension/contraction cylinders 137 may be configured instead of the elastic springs 135.

According to an embodiment of the present invention, as described above, the moving rails 130 are installed to be slidably drawn in or out of the insides of the roof fixing rails 120.

However, as shown in FIGS. 9 and 10, according to the present invention, the moving rails 130 may be connected to the ends of the roof fixing rails 120 to extend up to the external panel of the rear trunk T of the vehicle and to be fixedly installed.

In other words, according to another embodiment of the present invention, a second bending part 230 is provided at the connection portion between the roof fixing rail 120 and the moving rail 130 to be bent in one direction (upwards, direction indicated by arrow B, or direction outward of the trunk).

Thus, the moving cart 140, which is installed to slide along the roof fixing rails 120, may be slid from the roof fixing rails 120 through the second bending parts 230 to the ends (the rear lower ends of the trunk) of the moving rails 130.

The second bending part 230 is formed to be bendable in the form of a chain with multiple joint structures 231 continuously connected. The joint structure 231 includes an upper plate 231a forming an upper surface and a pair of side plates 231b provided downward from two opposite sides of the upper plate 231a. The side plate 231b includes a rounded protruding portion 231c, which has a first pivot pin hole h1 through which the pivot pin 231p is inserted, at one side portion (the front end) and a recess portion 231d, which has a second pivot pin hole h2 through which the pivot pin 231p is inserted, and to which the rounded protruding portion 231c is rotatably fitted, at the opposite side portion (the rear end).

An upper jaw 231e formed by the upper plate 231a is provided on the upper surface of the rounded protruding portions 231c, and a lower jaw 231f is provided on the lower surface of the rounded protruding portions 231c.

The upper length L1 from the rear surface of the upper plate 231a to the upper jaw 231e is larger than the lower distance L2 from the lower rear end of the side plate 231b to the lower jaw 231f.

In the second pending part 230, if the rounded protruding portions 231c are fitted to the recess portions 231d through the pivot pin 231p, the joint structures 231 are pivotally connected to each other. If multiple joint structures 231 are assembled in such a manner to have a required length, the second bending part 230 is completed. In this case, two opposite ends of the second bending part 230 are connected by a separate connecting member (not shown).

Further, the second bending part 230 includes multiple left connection parts 230a, which are connected so that the rounded protruding portion 231c of the joint structure 231 faces to the right (as viewed in the drawings), multiple right connection parts 230b, which are connected so that the rounded protruding portion 231c of the joint structure 231 faces to the left (as viewed in the drawings) to face the left connection parts 230a, and intermediate media 232 connecting the left connection part 230a and the right connection part 230b.

In other words, the left connection part 230a and the right connection part 230b are provided to face each other with the intermediate medium 232 interposed therebetween.

The intermediate medium 232 includes an upper surface 232a, a lower surface 232b, and side surfaces 232c on two opposite sides. An upper surface distance L3 of the upper surface 232a is larger than a lower surface distance L4 of the lower surface 232b. Medium recess portions 232d are formed at the front and rear in the two opposite side surfaces 232c to allow the rounded protruding portions 231c to be pinned with the pivot pins 231p and pivoted.

Thus, since the second bending part 230 with multiple connected joint structures 231 is installed so that the upper surface is longer than the lower surface, they may be connected while being bent to form a rounded shape.

In other words, as shown in FIGS. 9 and 10, the upper jaw 231e formed on the front surface of the upper plate 231a comes in tight contact with the rear surface of the consecutive neighboring upper plate 231a, and the lower jaw 231f formed on the lower front surfaces of the side plates 231b forms a predetermined gap (hereinafter, referred to as a lower gap d1) from the lower rear surfaces of the consecutive neighboring side plates 231b.

As shown in (b) of FIG. 9, when the trunk T of the vehicle is open (lifted), the second bending part 230 is lifted in direction B while being forced on two opposite sides in directions A. At this time, as the joint structure 231 is pivoted about the pivot pin 231p, the lower gap d1 formed on the lower surface of the second bending part 230 is minimized, and the rear surface of the upper plate 231a and the upper jaw 231e in tight contact thereto are spread, forming an upper gap d2.

Therefore, when the trunk T of the vehicle is open, the second bending part 230 is lifted in direction A, preventing any issue with opening the trunk T (e.g., failure in opening the trunk when the second bending part 230 is curved in the direction opposite to the direction B). Further, in this case, the overall length of the upper surface of the second bending part 230 is increased due to the upper gap d2 whereas the overall length of the lower surface of the second bending part 230 is reduced as the lower gap d1 is minimized. When the trunk T is closed, the overall length of the lower surface of the second bending part 230 is increased while the overall length of the upper surface is reduced back to the original length.

As such, as the second bending part 230 is connected and fixed in a rounded shape on the roof fixing rails 120, the moving cart 140 may be easily slid down (descend) from the roof fixing rails 120 to the ends of the moving rails 130.

The second bending part 230 has been described as fixed to the rear of the vehicle, rather than extended. However, without being limited thereto, the shape of the bending part 130 is also possible.

As described above, according to the present invention, a vehicle rear roof carrier device includes roof supports fixed on two opposite sides of the roof of a vehicle in the length direction thereof, hollow roof fixing rails individually connected and fixed to the side surfaces of the roof supports, moving rails provided to the roof fixing rails and connected and installed up to the trunk, a moving cart slid along the roof fixing rails, and a carrier box detachable from the moving cart and receiving and storing articles. The moving rails are connected and installed up to a rear portion of the trunk, and the moving cart is moved down along the moving rails to load the carrier box with an article, so that it is possible to conveniently move down or up the carrier box to/from the roof of the vehicle to load or unload an article.

Legend of symbols

100: vehicle rear roof carrier device
110: roof support 111: base
120: roof fixing rail
130: moving rail
131: connection bracket 132: operating handle 132a: body part 132ab: recess portion
132b: handle part 132c: operation part 132d: locking structure 133: bending part
134: rear supporting bracket 135: elastic spring 136: pivot pin 137: extension/contraction cylinder
140: moving cart
141: body plate 142: roller unit 142a: front roller unit 142b: rear roller unit
142R: rotation roller 143: locking bracket 144: upper rail 144a: upper link
144b: lower link
150: carrier box
151: lower rail 151a: handle 152: carrier handle 153; detaching lever
160: cylinder device
161: front cylinder 162: rear cylinder
230: second bending part 230a: left connection part 230b: right connection part
231: joint 231a: upper plate 231b: side plate
231c: rounded protruding portion 231d: recess portion 231e: upper jaw 231f: lower jaw
231p: pivot pin h1: first pivot pin hole h2: second pivot pin hole
d1: lower gap d2: upper gap L1: upper distance L2: lower distance
L3: upper surface distance L4: lower surface distance
232: intermediate medium
232a: upper surface 232b: lower surface 232c: side surface 232d: medium recess portion

1. A vehicle rear roof carrier device, comprising:
a pair of roof supports (110) installed on two opposite sides in a length direction of a vehicle roof on an upper surface of the vehicle roof;
hollow roof fixing rails (120) connected and fixed to the roof supports (110);
moving rails (130) installed on the roof fixing rails (120) and extending up to a rear surface of a vehicle trunk;
a moving cart (140) installed on the roof fixing rails (120) and slid along outer surfaces of the roof fixing rails (120) and outer surfaces of the moving rails (130); and
a carrier box (150) installed on an upper surface of the moving cart (140) to receive and store an article.

2. The vehicle rear roof carrier device of claim 1, wherein the moving rails (130) are drawn out from insides of the roof fixing rails (120) and ends of the moving rails (130) are supported on the rear surface of the vehicle trunk.

3. The vehicle rear roof carrier device of claim 1, wherein the moving rails (130) are installed in pair on two opposite sides on the vehicle roof to face each other, wherein a connection bracket (131) is provided at respective ends of the moving rails (130) to connect the moving rails (130), and wherein an operating handle (132) is installed on the connection bracket (131) to draw the moving rails (130) in or out of the roof fixing rails (120).

4. The vehicle rear roof carrier device of claim 1, wherein bending parts (133) are provided in middle portions of the moving rails (130), each bending part (133) formed of a flexible connecting rod (133a) over which a plurality of rigid rings (133b) spaced apart from each other are fitted.

5. The vehicle rear roof carrier device of claim 1, wherein the moving cart (140) includes a plate-shaped body plate (141) on which the carrier box (150) is mounted, roller units (142) having first sides fixed and installed on a lower surface of the body plate (141) and second sides mounted and rollable on the roof fixing rails (120) and provided with rotation rollers (142R), and a locking bracket (143) provided on a rear lower surface of the body plate (141) and where the operating handle (132) is locked or unlocked to/from the moving rails (130) while being supported.

6. The vehicle rear roof carrier device of claim 5, wherein a cylinder device (160) including front cylinders (161) and rear cylinders (162) extendable or contractable forward or rearward is installed on the lower surface of the moving cart (140), wherein first ends of the front cylinders (161) are connected to a lower front side of the body plate (141), and second ends of the front cylinders (161) are connected to rear roller units (142b) of the roller units (142), and first ends of the rear cylinders (162) are connected to a lower rear side of the body plate (141), and second ends of the rear cylinders (162) are connected to front roller units (142a) of the roller units (142), so that the moving cart (140) ascends or descends as the front cylinders (161) and the rear cylinders (162) extend or contract.

7. The vehicle rear roof carrier device of claim 5, wherein the operating handle (132) includes a body part (132a) provided in a middle portion of the connection bracket (131) and having a recess portion (132ab) at an upper end thereof, which is supported to the locking bracket (143) provided on the lower surface of the moving cart (140), a handle part (132b) provided at a lower end of the body part (132a), an operation part (132c) provided in the handle part (132b), and a locking structure (132d) provided on a side of an upper portion of the body part (132a) and pivoted by the operation part (132c) to be locked or unlocked to/from the locking bracket (143).

8. The vehicle rear roof carrier device of claim 1, wherein the moving rails (130) are connected from the roof fixing rails (120) to the vehicle trunk, and wherein second bending parts (230) are provided in connection portions between the roof fixing rails (120) and the moving rails (130) and are bent outward of the vehicle trunk.

9. The vehicle rear roof carrier device of claim 8, wherein the second bending parts (230) are bendable in a form of a chain with a plurality of joint structures (231) connected consecutively, wherein each of the plurality of joint structures (231) includes an upper plate (231a) forming an upper surface thereof and a pair of side plates (231b) formed downward from two opposite surfaces of the upper plate (231a).

10. The vehicle rear roof carrier device of claim 9, wherein a first side portion of each of the side plates (131b) includes a rounded protruding portion (231c) having a first pivot pin hole h1 through which a pivot pin (231p) is inserted, and a second side portion thereof includes a recess portion (231d) having a second pivot pin hole h2 through which a pivot pin (231p) is inserted, and wherein a rounded protruding portion (231c) is rotatably fitted into the recess portion (231d).

11. The vehicle rear roof carrier device of claim 10, wherein an upper jaw (231e) formed by a front end of the upper plate (231a) is provided on an upper surface of the rounded protruding portion (231c), and a lower jaw (231f) is provided on a lower surface of the rounded protruding portion (231c), and wherein an upper distance (L1) from a rear surface of the upper plate (231a) to the upper jaw (231e) is larger than a lower distance (L2) from a rear lower end of the side plate (231b) to the lower jaw (231f).

12. The vehicle rear roof carrier device of claim 4, wherein a fixing pin (133c) penetrating the connecting rod (133a) is fixed to each of the rings (133b).

13. The vehicle rear roof carrier device of claim 4, wherein an interval between lower sides of the rings (133b) is equal to or larger than an interval between upper sides of the rings (133b).

14. The vehicle rear roof carrier device of claim 1, wherein upper rails (144) are provided in the length direction on an upper surface of the moving cart (140), and lower rails (151) are provided on a lower surface of the carrier box (150) to slide along the upper rails (144), and wherein the carrier box (150) is slid down along the upper rails (144) and is then detached from the moving cart (140).

15. The vehicle rear roof carrier device of claim 1, wherein upper rails (144) are provided in the length direction on an upper surface of the moving cart (140), and lower rails (151) are provided on a lower surface of the carrier box (150) to be coupled with the upper rails (144), wherein the upper rails (144) have pivotable links, and wherein the carrier box (150) is moved down by rotation of the links and is then detached from the moving cart (140).
